(19) United States
(12) Patent Application Publication
(10) Pub. No.: US 2017/0046660 A1
(43) Pub. Date: Feb. 16, 2017

(54) EVENT ORGANIZER

(71) Applicant: Roshini Sanah JAISWAL, New Delhi (IN)

(72) Inventor: Roshini Sanah JAISWAL, New Delhi (IN)

(21) Appl. No.: 15/236,413

(22) Filed: Aug. 13, 2016

(30) Foreign Application Priority Data
Aug. 14, 2015 (IN) 2511/DEL/2015

(51) Int. Cl. G06Q 10/10; H04L 29/08

(52) U.S. Cl. CPC G06Q 10/1093; H04L 67/306; G06Q 50/01

(57) ABSTRACT

Disclosed is a system for facilitating a user to organize an event via a social networking platform. A parameters detail receiving module receives pertaining to a set of profile parameters corresponding to each user of a plurality of users associated with a social networking platform. An event creation module enables a user, of the plurality of users, to create an event on the social networking platform. A user determination module determines a set of users of the plurality of users for sending an invitation to attend the event, wherein the set of users is determined based on correlation of the set of profile parameters with the plurality of event parameters. An invitation module sends the invitation to the set of users for attending the event and an acknowledgment to a subset of the set of users based on acceptance to the invitation by the subset.

### REFERENCE TO RELATED APPLICATIONS

The patent application claims the benefit of priority from Indian provisional application No. 2511/DEL/2015 filed on Aug. 14, 2015, the entirety of which is hereby incorporated by reference.

### TECHNICAL FIELD

The present disclosure in general relates to a field of social networking. More particularly, the present disclosure relates to a system and a method for organizing events.

### BACKGROUND

With the advent of Internet based social networking websites, including but not limited to, Facebook™, Twitter™, and Whatsapp™, the way of communication between users has changed drastically. Today, users of the social networking websites are virtually connected to their friends and family members via the social networking websites. The social networking websites enable the user to share posts, jokes, stock updates, and even broadcast social events within his and/or her connection on the social networking websites. Further it may be understood that, in today's world, face to face interactions have drastically reduced since people are connected virtually almost all the time over the social networking websites. Due to virtualization over social networking sites, people are slowly losing the very essence of meeting people in person and sharing their emotions with each other. Nowadays, social networking users prefer updating their social status' over the social networking websites rather than meeting friends and family members to share a laugh or a memory over a cup of coffee. People today are slowly realizing this, but often aren't able to do much, since the social networking websites have become a way of life.

Though some of the social networking websites do encourage in organizing events such as a get together, watching movie at theatres, and shopping with friends such that people can meet one another in person. However, the users of the social networking websites get spammed by too many of such event requests and thus ignore such receipt of invitation to the events. Further, there is no way by which a user can automatically control sending out invites to invitees on the social networking websites. Due to constant spamming of such event requests over the social networking websites, there is no encouragement sought by the user for meeting more people from his own social network.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts for facilitating a user to organize an event via a social networking platform and the concepts are further described below in the detailed description. This summary is not intended to identify essential features of the disclosure nor is it intended for use in determining or limiting the scope of the disclosure.

In one implementation, a system for facilitating a user to organize an event via a social networking platform is disclosed. In one aspect, the system may comprise a processor and a memory coupled to the processor. The processor may execute a plurality of modules stored in the memory. The plurality of modules may comprise a parameters detail receiving module, an event creation module, a user determination module, and an invitation module. The parameters detail receiving module may receive pertaining to a set of profile parameters corresponding to each user of a plurality of users associated with a social networking platform. The event creation module may enable a user, of the plurality of users, to create an event on the social networking platform. The event may be created upon receiving details, from the user, pertaining to a plurality of event parameters of the event. The user determination module may determine a set of users of the plurality of users for sending an invitation to attend the event. In one aspect, the set of users may be determined based on correlation of the set of profile parameters with the plurality of event parameters. The invitation module may send the invitation to the set of users for attending the event. The invitation module may further send an acknowledgment to a subset of the set of users based on acceptance to the invitation by the subset. The acknowledgment may indicate confirmation of slots reserved for the subset of the set of users in the event thereby facilitating the user to organize the event via the social networking platform.

In another implementation, a method for facilitating a user to organize an event via a social networking platform is disclosed. In order to facilitate the user to organize the event via the social networking platform, initially, details pertaining to a set of profile parameters may be received corresponding to each user of a plurality of users associated with a social networking platform. Upon receiving the details, a user, of the plurality of users, may be enabled to create an event on the social networking platform. In one aspect, the event may be created upon receiving details, from the user, pertaining to a plurality of event parameters of the event. Subsequently, a set of users of the plurality of users may be determined for sending an invitation to attend the event. The set of users may be determined based on correlation of the set of profile parameters with the plurality of event parameters. After determining the set of users, the invitation may be send to the set of users for attending the event. Upon sending the invitation, an acknowledgment may further be send to a subset of the set of users based on acceptance to the invitation by the subset. In one aspect, the acknowledgment may indicate confirmation of slots reserved for the subset of the set of users in the event thereby facilitating the user to organize the event via the social networking platform.

In yet another implementation, a non-transitory computer readable medium embodying a program executable in a computing device for facilitating a user to organize an event via a social networking platform is disclosed. The program comprising a program code for receiving details pertaining to a set of profile parameters corresponding to each user of a plurality of users associated with a social networking platform. The program may further comprise a program code for enabling a user, of the plurality of users, to create an event on the social networking platform, wherein the event is created upon receiving details, from the user, pertaining to a plurality of event parameters of the event. The program may further comprise a program code for determining a set of users of the plurality of users for sending an invitation to attend the event, wherein the set of users is determined based on correlation of the set of profile parameters with the plurality of event parameters. The program may further comprise a program code for sending the invitation to the set of users for attending the event, and an acknowledgment to a subset of the set of users based on acceptance to the invitation by the subset, wherein the acknowledgment indicates confirmation of slots reserved for the subset of the set of users in the event thereby facilitating the user to organize the event via the social networking platform.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for facilitating a user to organize an event via a social networking platform, in accordance with an embodiment of the present invention.

FIG. 2 illustrates a flowchart for organizing events by the system, in accordance with an embodiment of the present invention.

FIGS. 3A and 3B illustrate a Sign Page and a Login Page of the social networking platform, in accordance with an embodiment of the present invention.

FIG. 4 illustrates a Home Page of the social networking platform, in accordance with an embodiment of the present invention.

FIGS. 5A and 5B illustrate pages for creating different categories on the social networking platform, in accordance with an embodiment of the present invention.

FIGS. 6A, 6B, and 6C, illustrate pages for creating an event on the social networking platform, in accordance with an embodiment of the present invention.

FIGS. 7, 8, 9, and 10 illustrate Graphical User Interfaces (GUIs) of a social networking platform, in accordance with an embodiment of the present invention.

FIGS. 11 and 12 illustrate a method for facilitating the user to organize the event via the social networking platform, in accordance with an embodiment of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. For example, although the present disclosure will be described in the context of a system and method for facilitating a user to organize an event (hereinafter also referred to as ‘social event’) via a social networking platform, one of ordinary skill in the art will readily recognize that the method and system can be utilized in any situation where there is need to facilitate the user to organize the event via the social networking platform. Thus, the present disclosure is not intended to be limited to the embodiments illustrated, but is to be accorded the widest scope consistent with the principles and features described herein.

The present system and method facilitates the user to organize the event via the social networking platform is disclosed. Examples of the social event may include, but not limited to, having dinner, watching movies with friends and family, and other social activities which involve meeting invitees in person. For this purpose, the system provides the social networking platform such that a user may reach out to his/her network of friends and plan as many social events as possible. This may encourage and remind the users of the social networking platform to meet more often by syncing pre-scheduled calendar events and their locations with each other.

In order to organize the event via the social networking platform, the system may receive details pertaining to a set of profile parameters corresponding to each user of a plurality of users associated with the social networking platform. Upon receiving the details, a user, of the plurality of users, may create an event on the social networking platform. Subsequently, a set of users of the plurality of users may be determined for sending an invitation to attend the event. The set of users may be determined based on one or more rules. It may be understood that the social networking platform enables a rule engine to automatically manage sending of invitation based on the one or more rules. Thus, the rule engine is enabled to automatically send the invitation to invitees that are connected with the user through the social networking platform.

In one embodiment, the system may be configured to send limited number of invitation to a set of users present in the contact list of the user. In one aspect, the set of users may be determined based on an event parameter, of a plurality of event parameters, indicating a count of invitees to be invited for the event. It may be understood that when a count of users of the set of users, accepted the invitation, is less than the count of invitees to be invited for the event, the system determines a subsequent set of users of the plurality of users for sending the invitation to attend the event. In one aspect, the system may further determine the subsequent set of users when the invitation is pending, for acceptance, with one or more users of the set of users until a predefined time interval.

Thus, based on the acceptance to the invitation received, the social networking platform automatically withdraws the invitation pending with the one or more users until the predefined time interval and sends a new invitation to the subsequent set of users. Further, the social networking platform encourages the user to meet a diverse set of people from his social circle by limiting the sending of invites to users who have met recently via the previous events created by the user.

In one embodiment, the system may further configured to limit the invitations to be sent to one or more users who are having a score less than a predefined threshold score. In one aspect, the score may be computed based on a frequency of users who initially accepts the invitation and later cancels the invitation. In other words, the one or more users who are frequently accepting the invitation to the event and later cancels or unattended the event, then such users are assigned with the score less than the predefined threshold score. While aspects of described system and method for organizing events may be implemented in any number of different computing systems, environments, and/or configurations, the embodiments are described in the context of the following exemplary system.

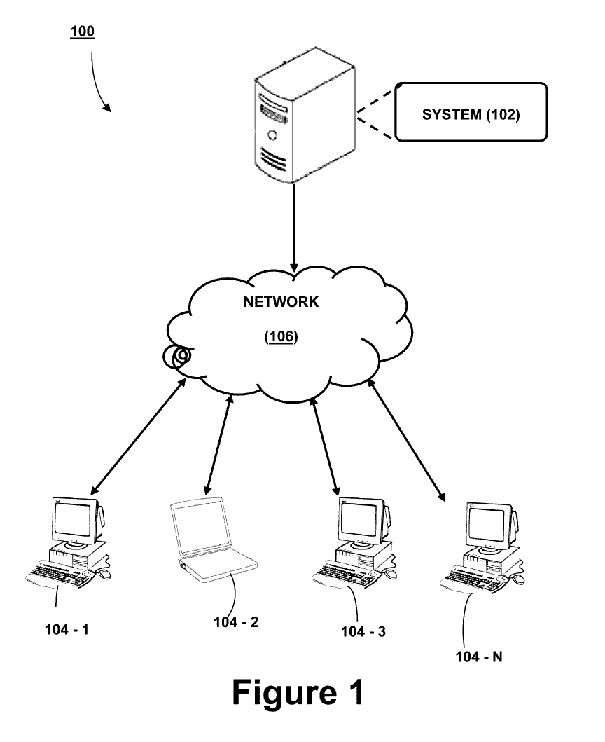

Referring now to FIG. 1, a network implementation 100 of a system 102 for facilitating a user to organize an event via a social networking platform. In order to facilitate the user to organize the event, initially, the system 102 receives details pertaining to a set of profile parameters corresponding to each user of a plurality of users associated with a social networking platform. Upon receiving the details, the system 102 enables a user, of the plurality of users, to create an event on the social networking platform. In one aspect, the event may be created upon receiving details, from the user, pertaining to a plurality of event parameters of the event. Subsequently, the system 102 determines a set of users of the plurality of users for sending an invitation to attend the event. The set of users may be determined based on correlation of the set of profile parameters with the plurality of event parameters. After determining the set of users, the system 102 sends the invitation to the set of users for attending the event. Upon sending the invitation, the system 102 sends an acknowledgment to a subset of the set of users based on acceptance to the invitation by the subset. In one aspect, the acknowledgment may indicate confirmation of slots reserved for the subset of the set of users in the event thereby facilitating the user to organize the event via the social networking platform.

Although the present disclosure is explained by considering that the system 102 is implemented as an application on a server, it may be understood that the system 102 may also be implemented in a variety of computing systems, such as a laptop computer, a desktop computer, a notebook, a workstation, a mainframe computer, a network server, and the like. It will be understood that the system 102 may be accessed by multiple users through one or more user devices 104-1, 104-2 . . . 104-N, collectively referred to as user devices 104 hereinafter, or applications residing on the user devices 104. In one implementation, the system 102 may comprise the cloud-based computing environment in which a user, interchangeably may referred to as a consumer, may operate individual computing systems configured to execute remotely located applications. Examples of the user devices 104 may include, but are not limited to a mobile phone, a smart phone, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

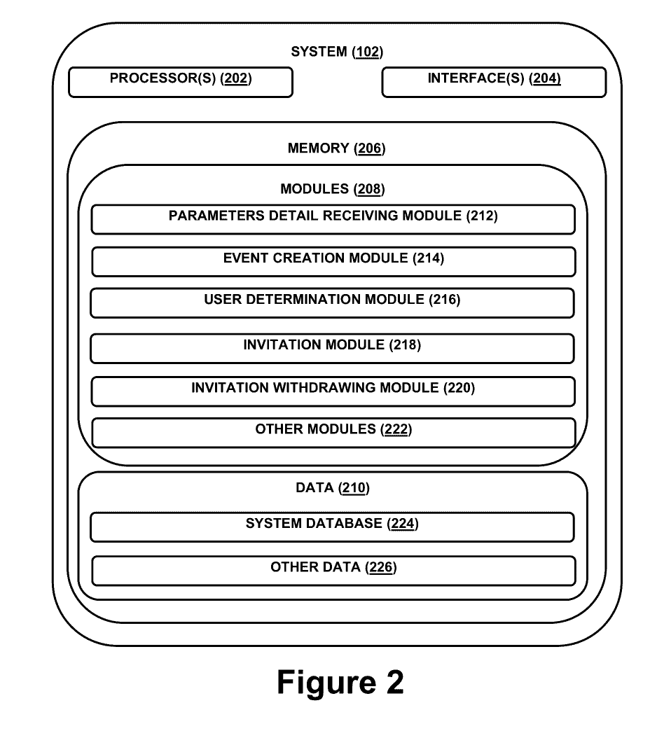

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a parameters detail receiving module 212, an event creation module 214, a user determination module 216, an invitation module 218, an invitation withdrawing module 220, and other modules 222. The other modules 222 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 224 and other data 226. The other data 226 may include data generated as a result of the execution of one or more modules in the other modules 222. The detailed description of the modules 208 along with other components of the system 102 is further explained by referring to FIG. 2.

In one implementation, at first, a user may use the user device 104 to access the system 102 via the I/O interface 204. The user may register themselves using the I/O interface 204 in order to use the system 102. In one aspect, the user may accesses the I/O interface 204 of the system 102 for facilitating a user to organize an event via a social networking platform. It may be understood that the user may send the request to connect with friends and family members who are already using the social networking platform and accordingly build his/her social network. In one embodiment, the social networking platform may automatically analyse the contact list of the user and send invites to encourage other members in his contact list to join the user over the system 102 using the social networking platform. Once the user's social network is generated, the user may reach out to his friends/family members in the social network to plan as many social events as possible. In order to facilitate the user to organize the event via the social networking platform, the system 102 may employ the plurality of modules i.e. the parameters detail receiving module 212, the event creation module 214, the user determination module 216, the invitation module 218, and the invitation withdrawing module 220. The detailed working of the plurality of modules is described below.

In one implementation, the system 102 may facilitate the user to organize the event (hereinafter also referred to as ‘social event’) including, but not limited to, dinner, watching movies, get together and other social activities which involve meeting friends or family members in person. To organize the social event, the system 102 either enables the user to download and install a social networking platform onto his and/or her user device 104 or allow the user to access the social networking platform on the web through his and/or her user device 104. Once the user is logged into the social networking platform, the parameters detail receiving module 212 receives details pertaining to a set of profile parameters corresponding to each user of a plurality of users associated with the social networking platform. The set of profile parameters may include, but not limited to, name, age, gender, hobbies, and location information.

Subsequent to the receipt of the set of profile parameters, the event creation module 214 may enable a user, of the plurality of users, to create an event on the social networking platform. In one aspect, the event may be created upon receiving details, from the user, pertaining to a plurality of event parameters of the event. The plurality of event parameters may include, but not limited to, an event name, an event location, a count of invitees to be invited for the event.

After the event has been created on the social networking platform, the user determination module 216 determines a set of users of the plurality of users for sending an invitation to attend the event. In order to send the invitation, the user determination module 216 determines a count of the set of users based on an event parameter, of the plurality of event parameters, indicating a count of invitees to be invited for the event. Based on the count of invitees to be invited in the event, the determination module 216 determines the set of users for sending the invitation. For instance, if the count of invitees to be invited in the event is ‘30’ users then the count of users may be determined for sending the invitation is ‘60’ users i.e. ‘2’ times the count of invitees to be invited in the event. In one embodiment, the count of invitees may be ‘x’ times the count of invitees to be invited in the event. Further it may be understood that the user determination module 216 determines the set of user, to be invited, based on correlation of the set of profile parameters with the plurality of event parameters.

In addition to above, the user determination module 216 may further determines the set of users to be invited based on following rules i.e. if more than one sub-Group is selected by the user, the invites are divided equally between the sub-groups according to the gender selection specified by the user. Further, if in-case no gender selection is specified by the user, an equal split is considered during sending invites.

In order to elucidate the functioning of the aforementioned modules, consider an example where a user U₁ creates an event for a cricket tournament on the social networking platform. While creating the event, user U₁ provides the plurality of event parameters details i.e. Event name as ‘Cricket Tournament’, Event location as Sports Ground, New Delhi′, and Count of Invitees as ‘30’. Upon receiving the details pertaining to the plurality of event parameters, the user determination module 216 may determine the set of users for sending the invitation to attend the event. It may be understood that the user determination module 216 determines the set of users upon correlating the plurality of event parameters with the set of profile parameters.

Upon correlation, the user determination module 216 determines ‘60’ users (i.e. 2 times the count of invitees to be invited in the event), amongst the plurality of users of the social networking platform, who are within a predefined range of the ‘Sports Ground, New Delhi’ and having one of the hobbies as ‘Playing Cricket’. Thus, in this manner, ‘60’ users may be determined for sending the invitation to attend the event.

In one embodiment, after determination of the set of users to be invited in the event, the invitation module 218 sends the invitation to the set of users for attending the event. The invitation module 218 may further send an acknowledgment to a subset of the set of users based on acceptance to the invitation by the subset. In one aspect, the acknowledgment may indicate confirmation of slots reserved for the subset of the set of users in the event thereby facilitating the user to organize the event via the social networking platform. It may be understood that the acknowledgment may be sent to the subset of the set of users based on First Come First Serve (FCFS) scheduling algorithm. Further referring to the same example, as aforementioned, the invitation module 218 then sends the invitation to ‘60’ users that have been determined by the user determination module 216. Upon sending the invitation to ‘60’ users, the invitation module 218 further sends the acknowledgment to those users, amongst the ‘60’ users, who have accepted the invitation to attend the event.

It may be understood that the system 102 is configured to send limited invitations to the set of users for a particular social event, as determined based on the event parameter indicating the count of invitees to be invited for the event. Further, based on the acceptance to the invitation, the invitation withdrawing module 220 may withdraw the invitation pending with one or more users, of the set of users, until the predefined time interval. In other words, the invitation withdrawing module 220 automatically withdraw the invitations sent to the one or more users of the set of users that are expired after a predefined time interval.

After withdrawing the invitations from the one or more users, the user determination module 216 further determines a subsequent set of users of the plurality of users for sending the invitation to attend the event. In one aspect, the subsequent set of users may be determined when a count of users of the set of users, accepted the invitation, is less than the count of invitees to be invited for the event and the invitation is pending, for acceptance, with one or more users of the set of users until a predefined time interval. Upon determination of the subsequent set of users, the user determination module 216 further sends the invitation to the subsequent set of users for attending the event. Thus, in this manner, the system 102 facilitates to organize the event by sending the invitations to the plurality of users of the social networking platform.

In order to further elucidate the functioning of the user determination module 216, consider the same example as aforementioned where the user determination module 216 determines ‘60’ users for sending the invitation to attend the event. Further it may be understood that, out of ‘60’ users, only 20 users have accepted the invitation to the event i.e. ‘Cricket Tournament’ whereas other ‘40’ users have not accepted the invitation. Since the User U₁ has provided the details that the ‘Count of Invitees’ to be invited in the event is ‘30’, the invitation withdrawing module 220 withdraws the invitation pending with ‘40’ users who have not accepted the event until the predefined time interval. Subsequently, the user determination module 216 further determines the subsequent set of users for sending the invitation to attend the event. Therefore, the user determination module 216 may then send the invitation to ‘20’ new users to attend the event.

In addition to the above, the system 102 may further configured to limit the sending of the invitation to one or more users having a score less than a predefined threshold score. In one aspect, the score may be computed based on a frequency of users who initially accepts the invitation and later cancels the invitation. In other words, the one or more users who are frequently accepting the invitation to the event and later cancels or unattended the event, then such one or more users are assigned with the score less than the predefined threshold score. The sending of the invitation based on the score may help in sending the invitation only to those users which are more considerate and having high provability for attending the event. In one embodiment, the system 102 may further be configured to create a group chat window amongst the users who have accepted the invitation to the event that enables the users to communicate with each other.

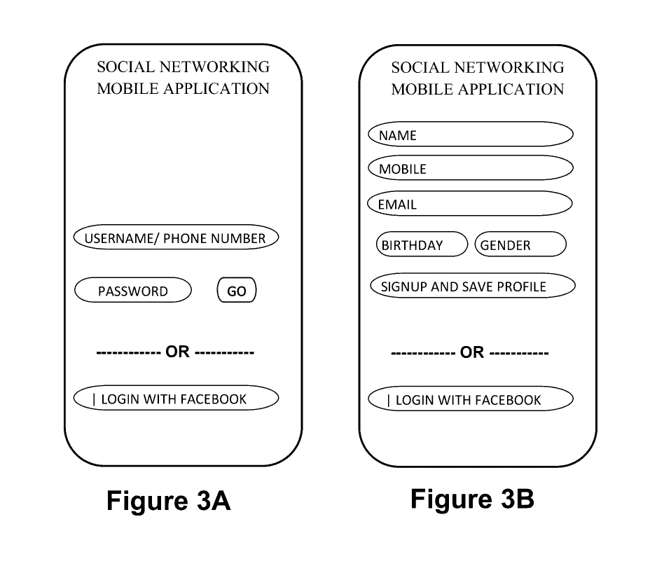

Referring now to FIGS. 3A and 3B, a sign in page 302 and a login page 304 respectively of the system 102, hereinafter also referred to as a social networking platform, are shown. As illustrated, after installing the social networking platform over the user device 104, the user may create his and/or her profile on the social networking platform using the sign-in page, as illustrated in the FIG. 3A. Upon creating the profile on the social networking platform, the user may log into the social networking platform, via the login page as illustrated in the FIG. 3B, for creating an event on the social networking platform. In one embodiment, the user may also log into the social networking platform by using his and/or her Facebook™ login credentials.

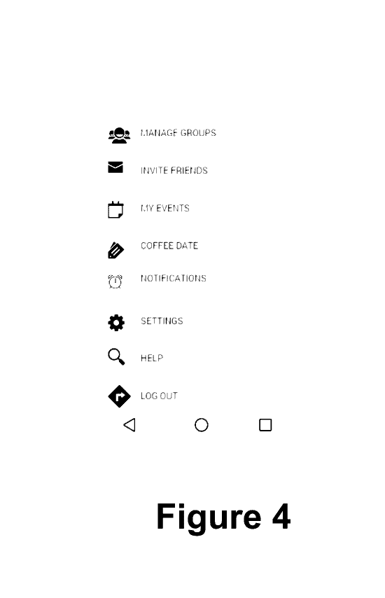

Referring to FIG. 4, a home page of the social networking platform is shown. The home page may facilitate navigation options to the user such as Manage Groups, Invite Friends, My Events, Coffee Date, Notifications, Settings, Help and Logout. Manage Groups facilitates the user to manage different groups of users such as family, friends, or acquaintances. In one aspect, Invite Friends facilitates the user to send invitation to a set of users to be invited for the event. My Events facilitates the user to organize one or more events associated with the user. Coffee Date is a template event that enables the user to send invitation to a set of users for a coffee date. Notifications facilitate the user to keep updated pertaining to the one or more events. Settings facilitate the user to change the configuration of the social networking platform.

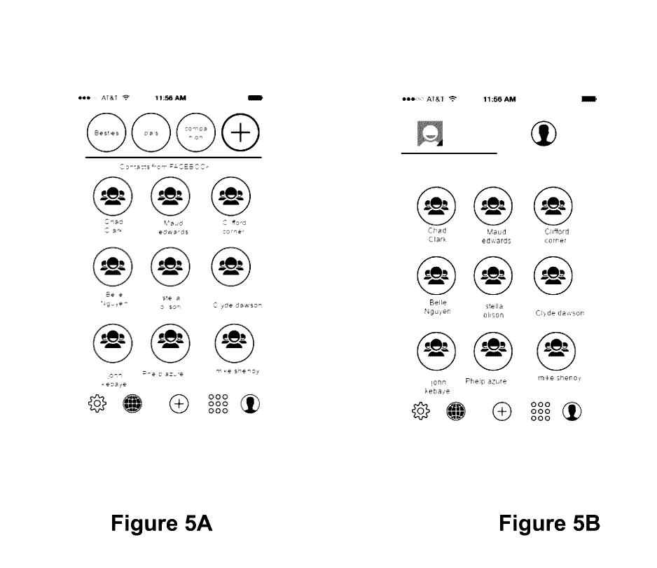

Referring to FIGS. 5A and 5B, Manage Groups Page of the social networking platform is shown. As illustrated in the FIG. 5A, the Manage Groups Page may facilitate classify the user to classify his/her connections on the social networking platform into at least one category. Examples of the at least one category may include, but not limited to, such as Besties, Pals, Companion, Friends, Family, Office colleges and the like. In one aspect, the Manage Groups Page may also enable the user to classify his and/or her contacts into one or more groups such as ‘Besties’, ‘Pals’, and ‘Companion’ etc. It may be understood that the user may create any number of categories as per his/her desire. In one aspect, when the user wishes to check who all are categorized in a specific category, the user be enabled to click on an icon indicating a specific category. Upon clicking the icon, all the connections that are categorized in the specific category, by the user, may be displayed on the GUI of the social networking platform. For example, as shown in the FIG. 5B, when the user clicks on ‘Besties’ category, the system 102 displays a list of contacts that have been classified as ‘Besties’.

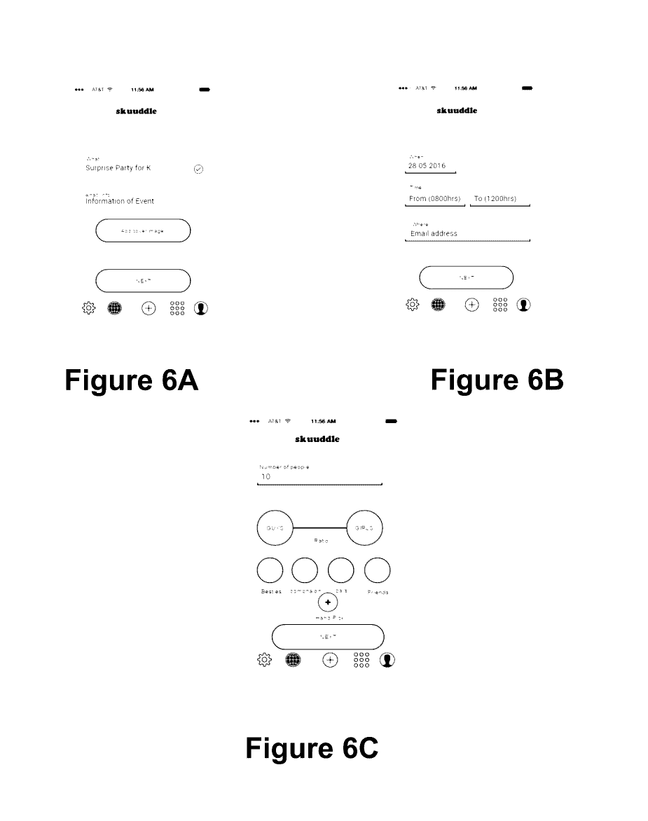

Referring to FIGS. 6A, 6B and 6C, a Create Event Page(s) of the social networking platform are illustrated. It may be understood that, in order to create an event on the social networking platform, details pertaining to a set of event parameters associated to the event may be received from the user creating the event. More specifically, in order to create any event, the user may provide details such as Title for the Event (What), some information about the event (What info), and Upload pictures of the event (if any) as illustrated in the FIG. 6A. Further, the user may provide details such as date of the event (When), event time (Time), and location information (Where) as illustrated in the FIG. 6B. Furthermore the user may provide details such as a count of invitees to be invited for the event (number of people), Ratio of males and females to be invited in the event as illustrated in the FIG. 6C. Thus, upon receipt of the details pertaining to the set of event parameters, the system 102 automatically sends invitations to the members of the selected sub group and accordingly takes different actions based on the response received from the users in the sub group.

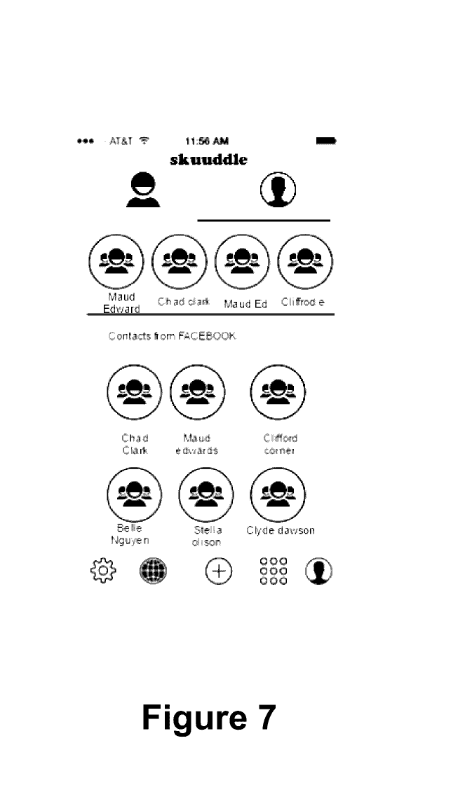

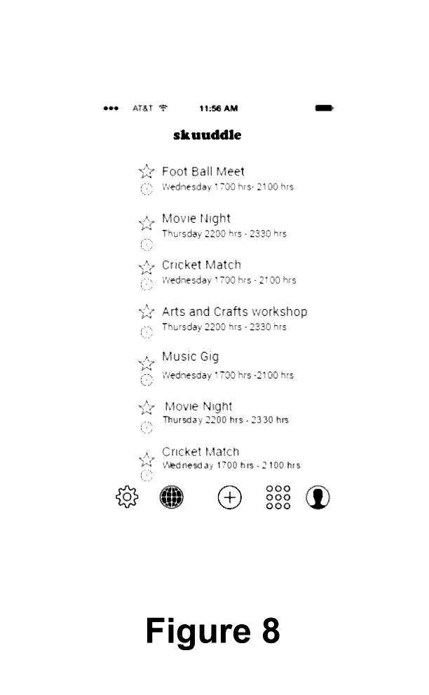

FIG. 7 illustrates Add More Friends Page displaying a list of friends to be categorized in a specific category. In one aspect, the user may manually select one or more friends from the list of friends of and categorized in a specific category. In one embodiment, the friends may be added by dragging a profile picture of the list of friends to be added from a social networking website such as Facebook™. Based on the selection made by the user, the system 102 may automatically send invites for the event to the selected members. Referring to FIG. 8 illustrating My Events Page of the social networking platform. In one aspect, My Events Page displays all the events that are created by the user on the social networking platform with their respective event date and time.

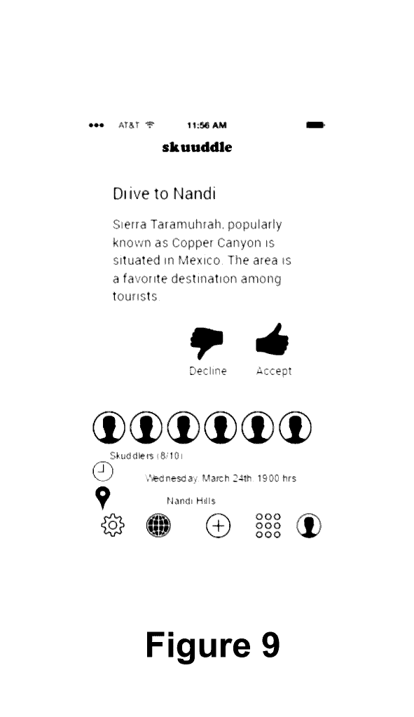

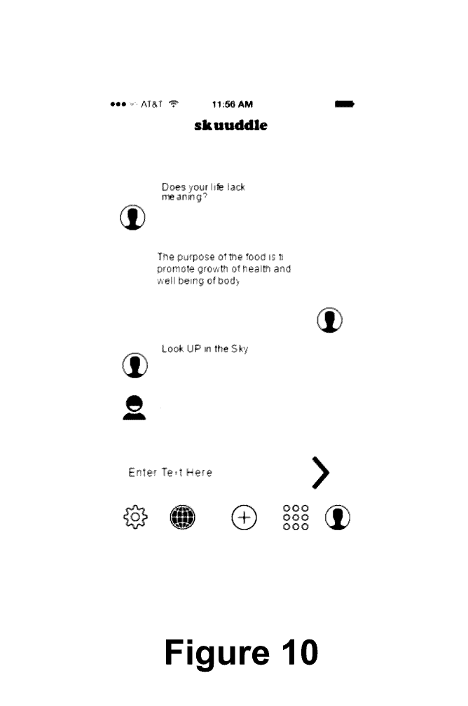

Referring to FIG. 9, an Event Invitation Page. The Event Invitation Page displays details of an event created by the user, wherein the details comprise an event name, an event location, an event date, a count of invitees to be invited for the event. Upon receiving the invitation to the event, the user may send his and/or her consent to attend the event using the Event Invitation Page by accepting the invitation icon, as illustrated in the FIG. 9. Further, the user may also be facilitated to check a list of other users who have accepted the invitation for attending the event. Now referring to FIG. 10, a Group Chat Window Page. In one embodiment, the system 102 further dynamically creates the Group Chat Window Page for the users who have accepted the invitation. The group chat window may facilitate the users to communicate amongst each other and accordingly make their plans for the event. In one embodiment, the group chat window may be automatically discarded once the event is over.

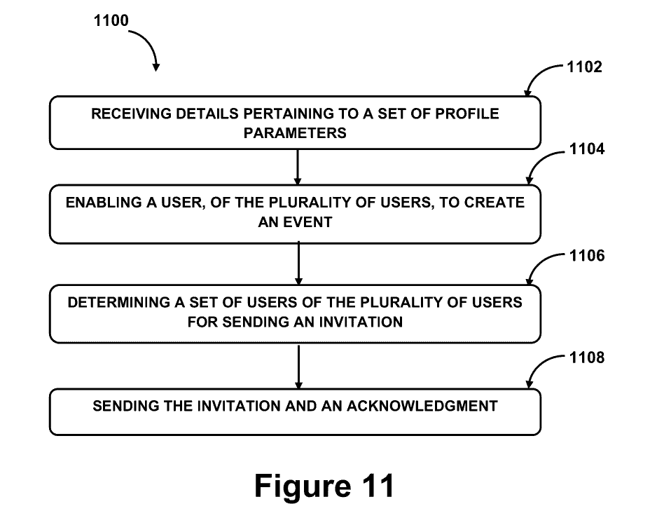

Referring now to FIG. 11, a method 1100 for facilitating a user to organize an event via a social networking platform is shown, in accordance with an embodiment of the present disclosure. The method 1100 may be described in the general context of computer executable instructions. Generally, computer executable instructions can include routines, programs, objects, components, data structures, procedures, modules, functions, etc., that perform particular functions or implement particular abstract data types. The method 1100 may be practiced in a distributed computing environment where functions are performed by remote processing devices that are linked through a communications network. In a distributed computing environment, computer executable instructions may be located in both local and remote computer storage media, including memory storage devices.

The order in which the method 1100 is described is not intended to be construed as a limitation, and any number of the described method blocks can be combined in any order to implement the method 1100 or alternate methods. Additionally, individual blocks may be deleted from the method 1100 without departing from the spirit and scope of the disclosure described herein. Furthermore, the method can be implemented in any suitable hardware, software, firmware, or combination thereof. However, for ease of explanation, in the embodiments described below, the method 1100 may be considered to be implemented in the above described in the system 102.

At block 1102, details pertaining to a set of profile parameters may be received corresponding to each user of a plurality of users associated with a social networking platform. In one implementation, the details may be received by the parameters detail receiving module 212.

At block 1104, a user, of the plurality of users, may be enabled to create an event on the social networking platform. In one aspect, the event may be created upon receiving details, from the user, pertaining to a plurality of event parameters of the event. In one implementation, the user may be enabled to create the event by the event creation module 214.

At block 1106, a set of users of the plurality of users may be determined for sending an invitation to attend the event. In one aspect, the set of users may be determined based on correlation of the set of profile parameters with the plurality of event parameters. In one implementation, the set of users may be determined by the user determination module 216.

At block 1108, the invitation and an acknowledgment may be sent to the set of users for attending the event and a subset of the set of users respectively. In one aspect, the acknowledgment may be sent based on acceptance to the invitation by the subset. The acknowledgment indicates confirmation of slots reserved for the subset of the set of users in the event thereby facilitating the user to organize the event via the social networking platform. In one implementation, the invitation and the acknowledgment may be sent by the invitation module 218.

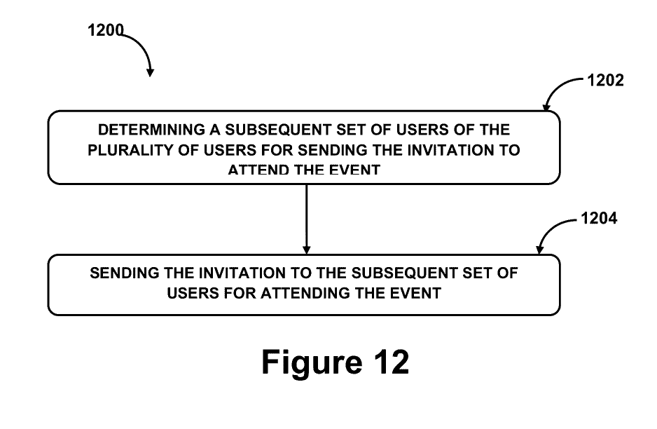

Referring now to FIG. 12, a method 1106 for determining a subsequent set of users of the plurality of users for sending the invitation to attend the event is shown, in accordance with an embodiment of the present subject matter.

At block 1202, determining a subsequent set of users for sending the invitation when a count of users of the set of users, accepted the invitation, is less than the count of invitees to be invited for the event and the invitation is pending, for acceptance, with one or more users of the set of users until a predefined time interval. In one implementation, the subsequent set of users may be determined by the user determination module 216.

At block 1204, the invitation may be sent to the subsequent set of users for attending the event. In one implementation, the invitation may be sent to the subsequent set of users by the invitation module 218.

Exemplary embodiments discussed above may provide certain advantages. Though not required to practice aspects of the disclosure, these advantages may include those provided by the following features.

Some embodiments enable a system and a method to automatically manage the process of sending invitations to invitees to be invited in an event.

Some embodiments enable a system and a method that encourages the users to meet a diverse set of people from his and/or her social circle.

Although implementations for methods and systems for facilitating a user to organize an event via a social networking platform have been described in language specific to structural features and/or methods, it is to be understood that the appended claims are not necessarily limited to the specific features or methods described. Rather, the specific features and methods are disclosed as examples of implementations for facilitating the user to organize the event via the social networking platform.

I/We claim:

1. A method for facilitating a user to organize an event via a social networking platform, the method comprising:
receiving, by a processor, details pertaining to a set of profile parameters corresponding to each user of a plurality of users associated with a social networking platform;
enabling, by the processor, a user, of the plurality of users, to create an event on the social networking platform, wherein the event is created upon receiving details, from the user, pertaining to a plurality of event parameters of the event;
determining, by the processor, a set of users of the plurality of users for sending an invitation to attend the event, wherein the set of users is determined based on correlation of the set of profile parameters with the plurality of event parameters; and
sending, by the processor,
the invitation to the set of users for attending the event, and
an acknowledgment to a subset of the set of users based on acceptance to the invitation by the subset, wherein the acknowledgment indicates confirmation of slots reserved for the subset of the set of users in the event thereby facilitating the user to organize the event via the social networking platform.

2. The method of claim 1, wherein the set of profile parameters comprises name, age, gender, hobbies, location information and wherein the plurality of event parameters comprises an event name, an event location, an event date, a count of invitees to be invited for the event.

3. The method of claim 1, wherein a count of the set of users is determined based on an event parameter, of the plurality of event parameters, indicating a count of invitees to be invited for the event.

4. The method of claim 3 further comprising
determining, by the processor, a subsequent set of users of the plurality of users for sending the invitation to attend the event, wherein the subsequent set of users is determined when
a count of users of the set of users, accepted the invitation, is less than the count of invitees to be invited for the event, and
the invitation is pending, for acceptance, with one or more users of the set of users until a predefined time interval; and
sending, by the processor, the invitation to the subsequent set of users for attending the event.

5. The method of claim 4 further comprises withdrawing the invitation pending with the one or more users until the predefined time interval.

6. The method of claim 1, wherein the acknowledgment is sent to the subset of the set of users based on First Come First Serve (FCFS) scheduling algorithm.

7. A system for facilitating a user to organize an event via a social networking platform, the system comprising:
a processor; and
a memory coupled to the processor, wherein the processor is capable of executing a plurality of modules stored in the memory, and wherein the plurality of modules comprising:
a parameters detail receiving module for receiving pertaining to a set of profile parameters corresponding to each user of a plurality of users associated with a social networking platform;
an event creation module for enabling a user, of the plurality of users, to create an event on the social networking platform, wherein the event is created upon receiving details, from the user, pertaining to a plurality of event parameters of the event;
a user determination module for determining a set of users of the plurality of users for sending an invitation to attend the event, wherein the set of users is determined based on correlation of the set of profile parameters with the plurality of event parameters; and
an invitation module for sending
the invitation to the set of users for attending the event, and
an acknowledgment to a subset of the set of users based on acceptance to the invitation by the subset, wherein the acknowledgment indicates confirmation of slots reserved for the subset of the set of users in the event thereby facilitating the user to organize the event via the social networking platform.

8. The system of claim 7, wherein the plurality of profile parameters comprises name, age, gender, hobbies, location information and wherein the plurality of event parameters comprises an event name, an event location, a count of invitees to be invited for the event.

9. The system of claim 8, wherein a count of the set of users is determined based on an event parameter, of the plurality of event parameters, indicating a count of invitees to be invited for the event.

10. The system of claim 9, wherein the user determination module further determines a subsequent set of users of the plurality of users for sending the invitation to attend the event, wherein the subsequent set of users is determined when a count of users of the set of users, accepted the invitation, is less than the count of invitees to be invited for the event and the invitation is pending, for acceptance, with one or more users of the set of users until a predefined time interval.

11. The system of claim 7 further comprising an invitation withdrawing module for withdrawing the invitation pending with the one or more users until the predefined time interval.

12. The system of claim 7, wherein the invitation module sends the acknowledgment to the subset of the set of users based on First Come First Serve (FCFS) scheduling algorithm.

13. A non-transitory computer readable medium embodying a program executable in a computing device for facilitating a user to organize an event via a social networking platform, the program comprising a program code:
a program code for receiving details pertaining to a set of profile parameters corresponding to each user of a plurality of users associated with a social networking platform;
a program code for enabling a user, of the plurality of users, to create an event on the social networking platform, wherein the event is created upon receiving details, from the user, pertaining to a plurality of event parameters of the event;
a program code for determining a set of users of the plurality of users for sending an invitation to attend the event, wherein the set of users is determined based on correlation of the set of profile parameters with the plurality of event parameters; and
a program code for sending
the invitation to the set of users for attending the event, and
an acknowledgment to a subset of the set of users based on acceptance to the invitation by the subset, wherein the acknowledgment indicates confirmation of slots reserved for the subset of the set of users in the event thereby facilitating the user to organize the event via the social networking platform.
